(19) United States
(12) Patent Application Publication
(10) Pub. No.: US 2014/0002657 A1
(43) Pub. Date: Jan. 2, 2014

(54) FORWARD COLLISION WARNING SYSTEM AND FORWARD COLLISION WARNING METHOD

(71) Applicant: LG INNOTEK CO., LTD., Seoul (KR)

(72) Inventors: Jun Chul KIM, Seoul (KR); Ki Dae KIM, Seoul (KR); K.S. KRISHNA, Seoul (KR); Manjunath V. ANGADI, Seoul (KR); Naresh Reddy YARRAM, Seoul (KR)

(21) Appl. No.: 13/932,203

(22) Filed: Jul. 1, 2013

(30) Foreign Application Priority Data
Jun. 29, 2012 (KR) 10-2012-0071226

(51) Int. Cl. B60Q 9/00

(52) U.S. Cl. CPC B60Q 9/008
USPC 348/148

(57) ABSTRACT

Disclosed are a forward collision warning system and a forward collision warning method. The forward collision warning system includes a photographing unit installed at a front of a vehicle to photograph an object in a forward direction of the vehicle; a driving unit that receives image data from the photographing unit to search for a forward candidate vehicle by classifying the image data using a predetermined mask, filters the candidate vehicle to settle an object corresponding to a real vehicle, tracks the object in a plurality of frames in order to add a missed object, and calculates a collision time based on a distance between the object and the vehicle to generate a warning generating signal according to the collision time; and a warning unit to generate a forward collision warning signal based on the warning generating signal received from the driving unit.

### CROSS-REFERENCE TO RELATED APPLICATION

This application claims the benefit under 35 U.S.C. §119 of Korean Patent Application No. 10-2012-0071226, filed Jun. 29, 2012, which is hereby incorporated by reference in its entirety.

### BACKGROUND

The embodiment relates to a forward collision warning system and a forward collision warning method.

In general, traffic accident preventing technologies are mainly focused on vehicle collision preventing technologies.

A technology dedicated for a single vehicle predicts collision between vehicles using information sensed from various sensors.

Further, a technology based on cooperation between vehicles senses collision between the vehicles by collecting various information from peripheral vehicles or an infrastructure system using a communication technology such as dedicated short-range communications (DRSC).

However, the traffic accident preventing technology according to the related art predicts traffic accident using locations, speed, and direction information of vehicles in cooperation with a vehicle system or receives traffic information from peripheral vehicles or an infrastructure system using a communication technology.

Accordingly, an interworking system is required between a warning system and a vehicle, and data may be polluted due to an erroneous operation of some system

### BRIEF SUMMARY

The embodiment provides a warning system capable of preventing an accident by warning an unexpected forward collision of a vehicle in a single system without cooperation with a vehicle system.

According to the embodiment, there is provided a forward collision warning system including a photographing unit installed at a front of a vehicle to photograph an object in a forward direction of the vehicle; a driving unit that receives image data from the photographing unit to search for a forward candidate vehicle by classifying the image data using a predetermined mask, filters the candidate vehicle to settle an object corresponding to a real vehicle, tracks the object in a plurality of frames in order to add a missed object, and calculates a collision time based on a distance between the object and the vehicle to generate a warning generating signal according to the collision time; and a warning unit to generate a forward collision warning signal based on the warning generating signal received from the driving unit.

The driving unit includes a vehicle searching unit that receives the image data from the photographing unit to search for the forward candidate vehicle by classifying the image data using the predetermined mask, and filters the candidate vehicle in order to settle the object corresponding to the real vehicle; a post processing unit that tracks the object in the plurality of frames to add the missed object; and a warning generating unit that calculates the collision time to generate the warning generating signal according to the collision time.

The driving unit further includes a vehicle tracking unit to track a current object based on the object of previous image data.

The vehicle searching unit and the vehicle tracking unit are selectively driven.

The vehicle searching unit and the vehicle tracking unit divide a region of interest such that a calculation value is assigned to each of the masks and compare a calculation value of a reference vehicle with a calculation value of the divided region of interest to extract the candidate vehicle.

The masks have mutually different shapes.

The vehicle searching unit and the vehicle tracking unit extract the candidate vehicle by using modified Haar classification.

The vehicle searching unit and the vehicle tracking unit settle the object except for a region, in which a real vehicle does not exist, by filtering a candidate vehicle through HOG and SVM classification.

The vehicle searching unit and the vehicle tracking unit check a history by overlapping an object of a current frame with an object of a previous frame.

The post processing unit compensates for the object by enlarging or reducing a boundary of the object.

Further, according to the embodiment, there is provided a forward collision warning method including photographing an object in a forward direction of the vehicle to generate image data; classifying the entire image data every n^{th} frame using a predetermined mask to search for a forward candidate vehicle, and filtering the candidate vehicle to settle an object corresponding to a real vehicle; searching for the forward candidate vehicle corresponding to data of a settled object of a previous frame among frames except for the n^{th} frame, and filtering the candidate vehicle to settle the object corresponding to the real vehicle; and calculating a collision time based on a distance between the object and the vehicle to generate a warning generating signal according to the collision time.

The searching of the candidate vehicle includes classifying the image data by using modified Haar classification.

The searching of the candidate vehicle includes settling the object except for a region, in which the real vehicle does not exist, by filtering a candidate vehicle through HOG and SVM classification.

The forward collision warning method further includes checking a history by overlapping an object of a current frame with an object of a previous frame.

The checking of the history includes determining that the objects of the current frame and the previous frame are the same when an overlap degree between the objects of the current frame and the previous frame is equal to or more than 70%.

The forward collision warning method further includes compensating for the object by enlarging or reducing a boundary of the object after the object is settled.

According to the embodiment, the functions of searching for and tracking a vehicle are proposed for and introduced to the system, so that the system can simply warn the forward collision of a vehicle.

Further, according to the embodiment, when a vehicle is detected, a candidate vehicle is determined by applying modified Haar classification and certified again by filtering the candidate vehicle so that the vehicle and surrounding environment are distinguished from each other, thereby improving the reliability.

### BRIEF DESCRIPTION OF THE DRAWINGS

FIG. 1 is a block diagram showing a configuration of a system according to the embodiment;

FIG. 2 is a flowchart illustrating an operation of the system of FIG. 1;

FIG. 3 is a flowchart illustrating the vehicle searching step of FIG. 2;

FIG. 4 is a view showing a configuration of a mask for illustrating modified Haar classification of FIG. 3;

FIGS. 5a and 5b are photographs showing a candidate vehicle acquired according to the modified Haar classification;

FIGS. 6a and 6b are photographs showing a certified candidate vehicle acquired through filtering certification;

FIG. 7 is a flowchart illustrating in detail a history checking step of FIG. 3;

FIGS. 8a and 8b are views showing a region of interest of a post processing;

FIG. 9 is a flowchart illustrating in detail a multiple tracking step;

FIGS. 10a and 10b are photographs showing a searched object through the multiple tracking step of FIG. 9; and

FIG. 11 is a photograph illustrating an executed boundary compensation.

### DETAILED DESCRIPTION

Hereinafter, embodiments will be described in detail with reference to accompanying drawings so that those skilled in the art can easily work with the embodiments. However, the embodiments may not be limited to those described below, but have various modifications.

In the following description, when a predetermined part “includes” a predetermined component, the predetermined part does not exclude other components, but may further include other components unless indicated otherwise.

The embodiment provides a system which may be mounted on a vehicle to warn of an abrupt lane departure of the vehicle while the vehicle is moving.

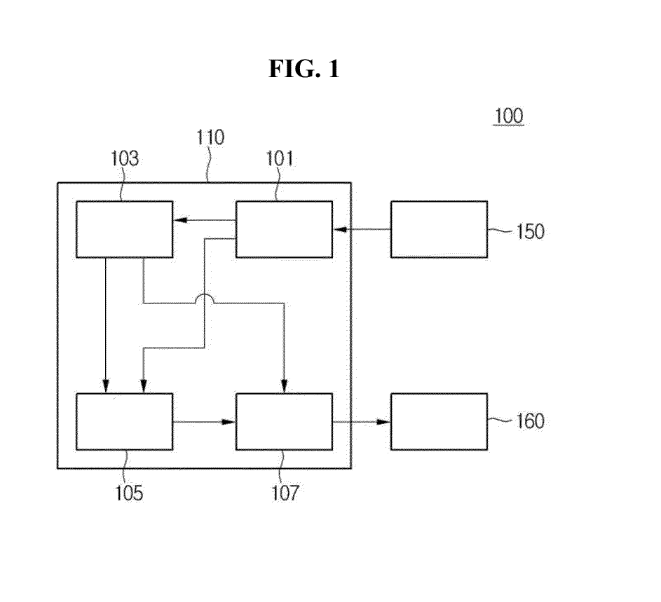

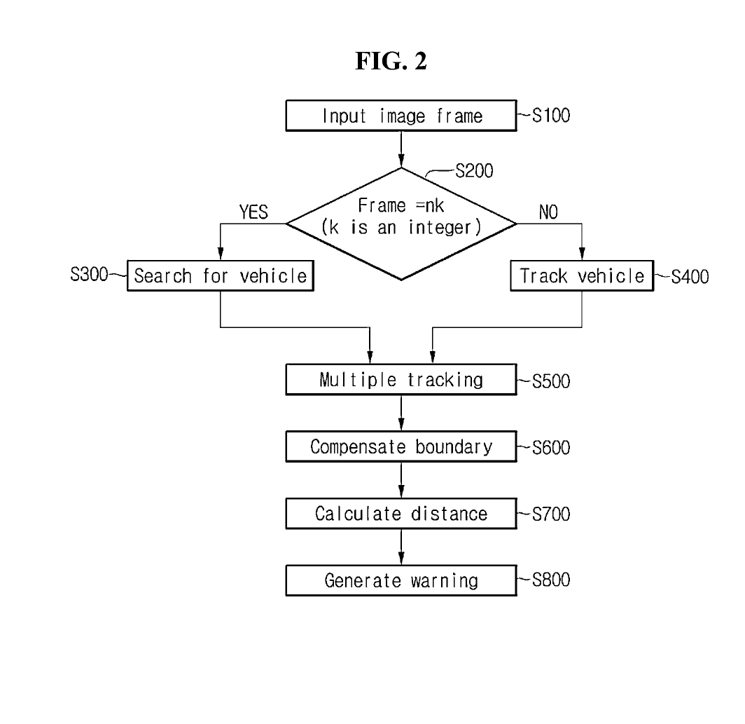

Hereinafter, a forward collision warning system will be described with FIGS. 1 and 2.

FIG. 1 is a view showing a system configuration according to the embodiment and FIG. 2 is a flowchart illustrating an operation of the system depicted in FIG. 1.

Referring to FIG. 1, the forward collision warning system 100 includes a photographing unit 150, a warning unit 160 and a driving unit 110.

The photographing unit 150 includes a camera of photographing a subject at a predetermined frequency, in which the camera photographs a front of a vehicle and transfers the photographed image to the driving unit 110.

In this case, the image photographing unit 150 may include an infrared camera which may operate at night, and may be operated by controlling a lighting system according to external environment.

The warning unit 160 receives a warning generating signal from the driving unit 110 and provides a lane departure warning signal to a driver.

In this case, the warning signal may include an audible signal such as alarm. In addition, the warning signal may include a visible signal displayed in a navigation device of the vehicle.

The driving unit 110 receives image data photographed by the image photographing unit 150 in units of frame (S100). The driving unit 110 detects a lane from the received image data, calculates a lateral distance between the lane and the vehicle, and then, calculates elapsed time until lane departure based on the lateral distance. When the elapsed time is in a predetermined range, the driving unit 110 generates the warning generating signal.

As shown in FIG. 1, the driving unit 110 may include a vehicle searching unit 101, a vehicle tracking unit 103, a post processing unit 105, and a warning generating unit 107.

The vehicle searching unit 101 receives image data corresponding to the nk^{TH} (n is an arbitrary integer, k=1, 2, 3, . . . , m) frame from the image photographing unit 150 (S100 and S200). The vehicle searching unit 101 searches for a forward vehicle in the image data (S300).

The vehicle tracking unit 103 receives image data from the image photographing unit 150 every when the image data do not correspond to the nk^{TH} (n is an arbitrary integer, k=1, 2, 3, . . . , m) frame, and compares the forward vehicle with a candidate vehicle in a previous frame to track the forward vehicle (S400).

Meanwhile, when the post processing unit 105 acquires the information about the candidate vehicle from the vehicle searching unit 101 or the vehicle tracking unit 103, the post processing unit 105 executes multiple tracking in which an object of the candidate vehicle in the current frame is defined by allowing a vehicle object of the previous frame to overlap the candidate vehicle of the current fame (S500), and compensates boundaries of each object so that the processing data are reduced (S600).

If the object of the current frame is defined by the post processing unit 105, a distance between the present vehicle and the object is calculated based on the image data (S700), and then, collision time of the object and the present vehicle is calculated by calculating speeds of the object and the present vehicle.

When the collision time is in a predetermined range, the warning generating unit 107 outputs a warning generating signal (S800)

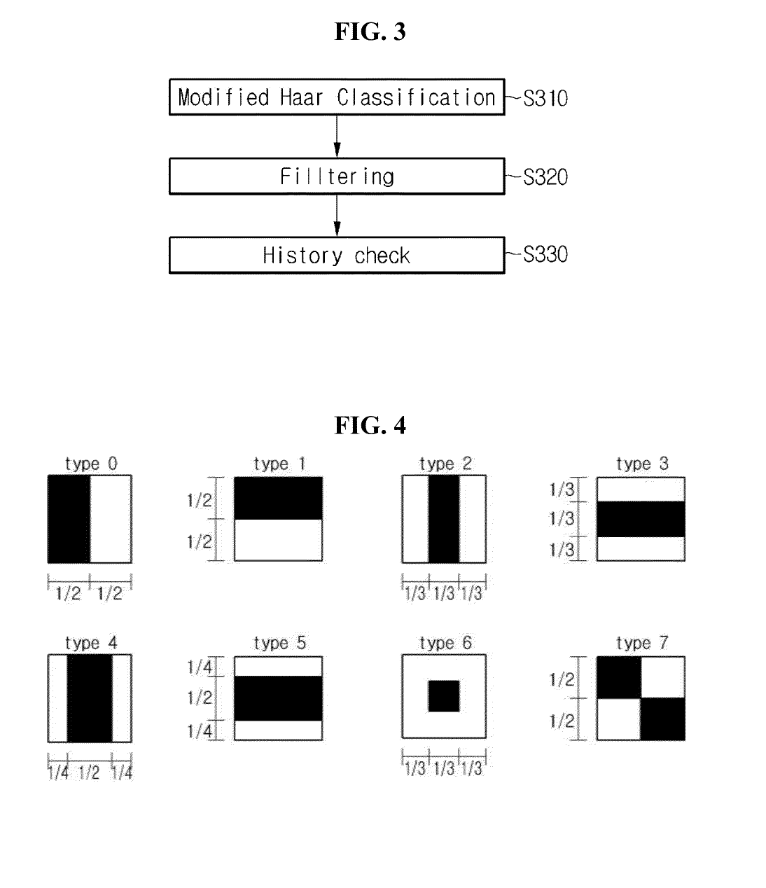

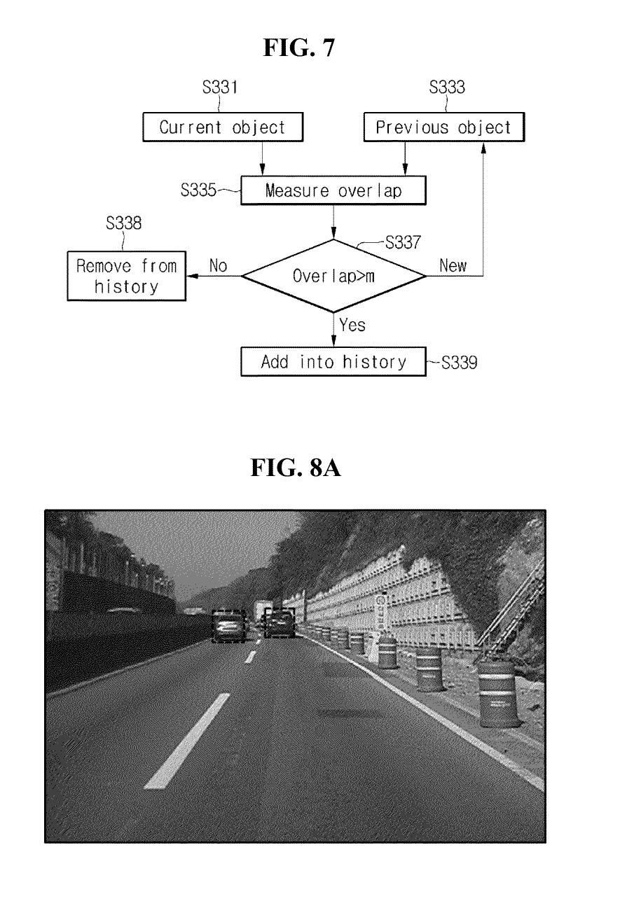

Hereinafter, each step will be described in more detail with reference to FIGS. 3 to 11.

First, as shown in FIG. 3, when a forward image in front of the vehicle is photographed by the image photographing unit 150, the vehicle searching unit 101 or the vehicle tracking unit 103 is selectively operated according to whether the corresponding frame is the nk^{TH} (n is an arbitrary integer, k=1, 2, 3, . . . , m) frame.

That is, the vehicle searching unit 101 is operated every nk^{th} frame to define a forward object vehicle serving as a reference.

The vehicle searching unit 101 receives the image data and searches for the candidate vehicle by using modified Haar classification (S310).

In the modified Haar classification, as shown in FIG. 4, the scanning is performed by using mutually different masks.

That is, while the image data are scanned with each mask as shown in FIG. 4, the pixel data in a back region is multiplied by ‘−1’ and the pixel data in a white region is multiplied by ‘+1’. Then, the sum of values of the masking region is calculated.

When the above-described calculations are performed for all image data with 8-types of masks as shown in FIG. 4, feature vectors for the 8-types of masks are obtained corresponding to each divided region of the image data subject to the masking.

After the feature vectors of each divided region are obtained, the feature vectors are compared with a plurality of stored reference feature vectors for a vehicle through a cascade adaboost algorithm so that the region determined as a vehicle is selected as the candidate vehicle.

The number and shape of the masks of FIG. 4 is not limited to the above, but the masks may be variously implemented. The size of the mask is not limited to the above, and the size may be enlarged in a specific direction.

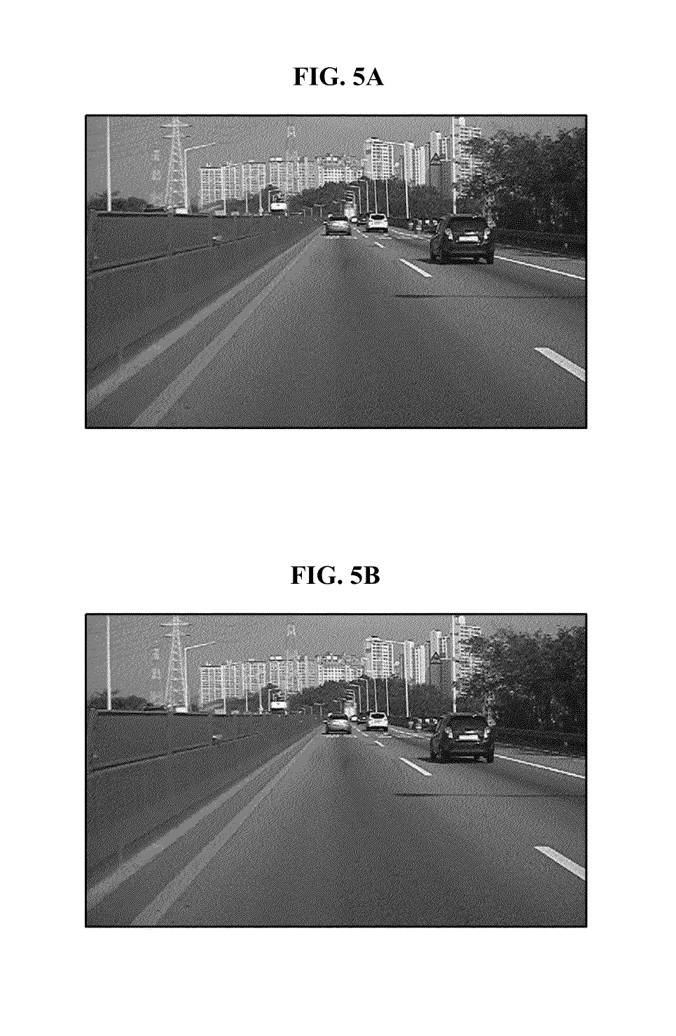

As the above classification is executed, as shown in FIG. 5b, the candidate vehicles appointed with the boxes are selected in the image data shown in FIG. 5a.

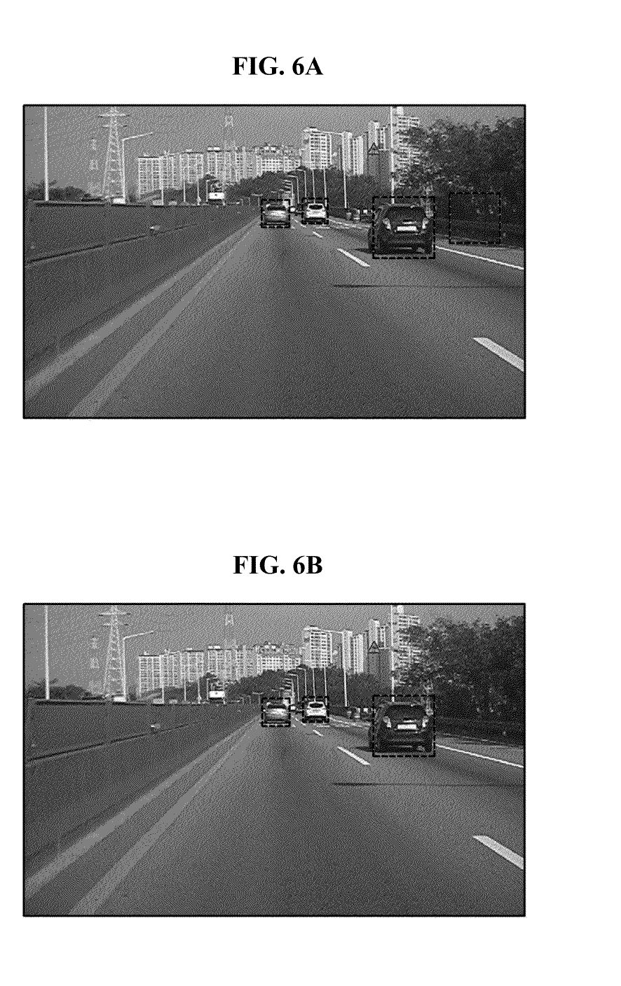

Then, as shown in FIGS. 6a and 6b, the vehicle objects among the candidate vehicles are only obtained through the filtering (S320).

That is, as shown in FIG. 5b, the candidate vehicles may include regions that do not match with real vehicles, so the filtering operation is performed to remove the regions.

The filtering operation may be performed through HOG (Histogram of Oriented Gradients) and SVM Cascade classification.

The candidate vehicles extracted through the Haar classification are defined as ROIs (Regions Of Interest) and horizontal and vertical gradients of the images in each ROI are calculated in the cascaded HOG and SVM classifications.

Then the ROI is spread into cells having a smaller size and a histogram for the corresponding gradient is formed. Then, after normalizing the histogram, the normalized histogram is grouped in predetermined units.

Then, the ROIs are sorted into real vehicle regions and non-real vehicle regions by using a linear SVM (Support Vector Machine) model.

Thus, as shown in FIG. 6b, the objects are acquired by filtering a peripheral region which is not a real vehicle from the candidate vehicles as shown in FIG. 6a.

Next, the history check of an object is performed to search for the ID of the corresponding object in an object list of a previous frame (S330).

If the history check begins, the data of the current object are input (S331) and the object data of a previous frame are input (S333).

The overlap of the current object and the object of the previous frame is performed to measure a degree of the overlap (S335).

When the overlap is equal to and greater than n (S337), it is determined that the current object is the same as that of the previous frame and an ID is defined (S339). When the overlap is equal to and less than m, it is determined that the current object is different from that of the previous frame so that the object is excluded from the history (S338).

When the object is not matched with any objects in the previous frame, the object is determined as a new object, so a new ID is assigned thereto and the object is added into the object list of the frame.

The m may be arbitrarily estimated and may be equal to or more than o.7.

Meanwhile, while the vehicle searching unit 101 is not driven, the vehicle tracking unit 103 is driven.

The vehicle tracking unit 103 selects and filters a candidate vehicle in through the Haar classification amended in the same way as the operation of the vehicle searching unit such that the objects are acquired, and then, checks the history to settle the ID of the object.

At this time, the operation of vehicle tracking unit is performed not for the entire image data but for a specific ROI.

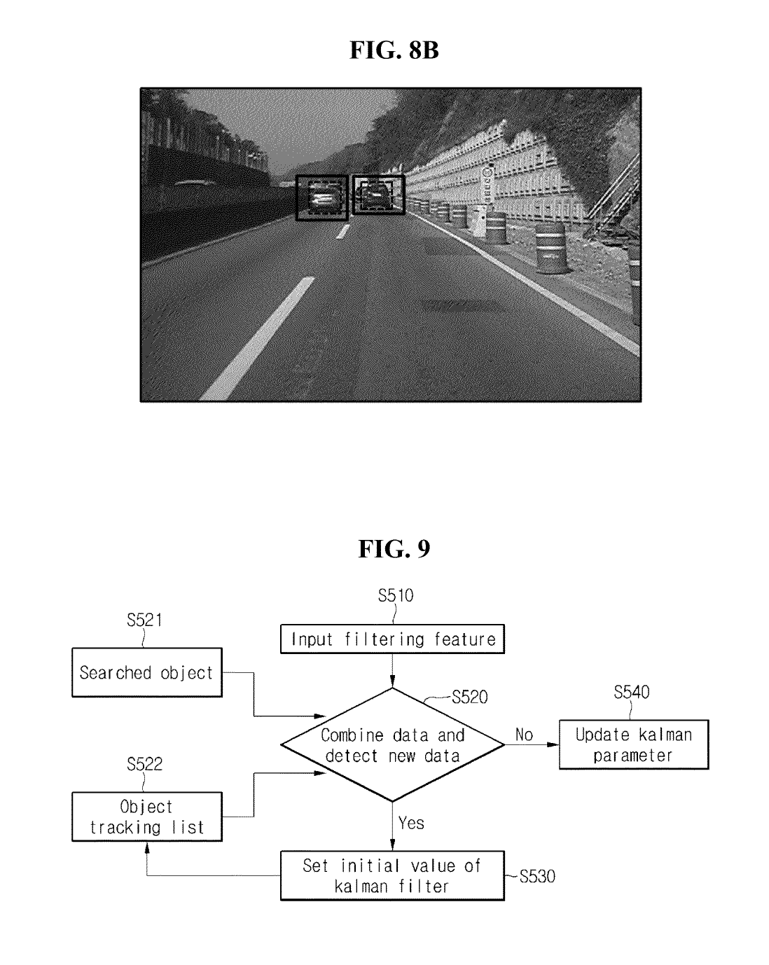

That is, when the object searched in the previous frame is settled as shown in FIG. 8a, the region extending with respect to the object of the previous frame may be selected as the ROI, as shown in FIG. 8b.

Thus, the object of the current frame included in a portion of the image data is tracked so that the calculation is simplified.

Next, the post processing operation of the post processing unit 105 begins.

First, the post processing unit 105 performs a multiple tracking operation to search for a missed forward vehicle.

Then, the filtering feature values of the corresponding object in a plurality of previous frames with respect to the acquired object (S521) are combined (S520) based on the feature value (S510) used in the previous filtering. If it is determined that the object is a new object, the object is added to the object list (S522) and the initial value of the kalman filter is set (S530).

If it is determined that the acquired object is not new object, the parameter of the kalman filter is updated (S540).

The kalman filter is used for predicting a place of the corresponding object between the plurality of frames and filtering the frames, but the embodiment is not limited thereto and in addition, searches for the missed forward vehicle through various method.

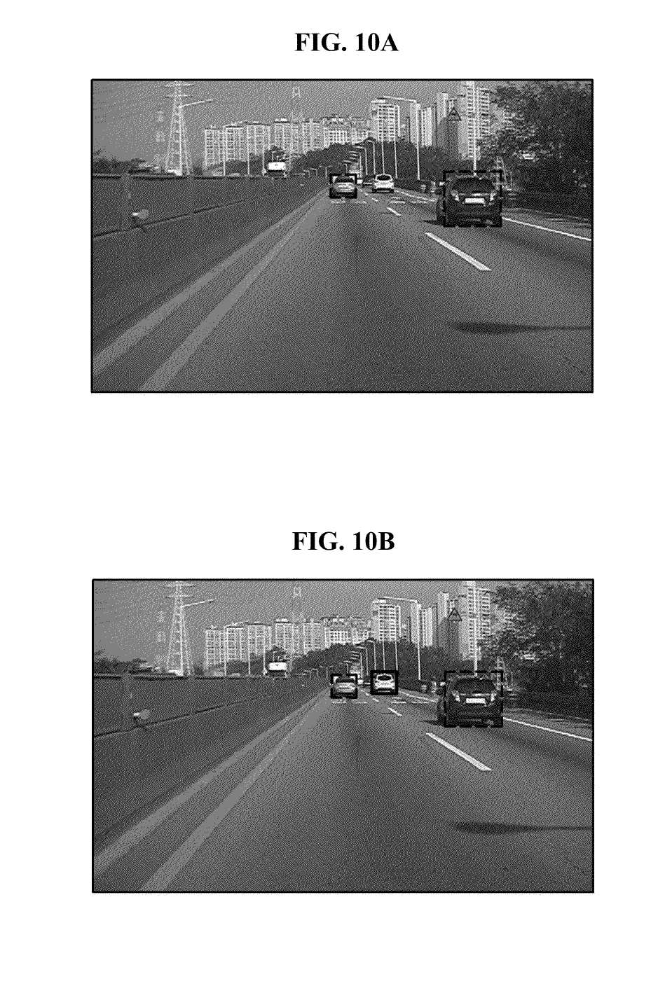

Thus, even if a missed vehicle exists in front of the vehicle as shown FIG. 10a, the missed vehicle may be further added as an object by performing the filtering of the plurality of frames as shown in FIG. 10b.

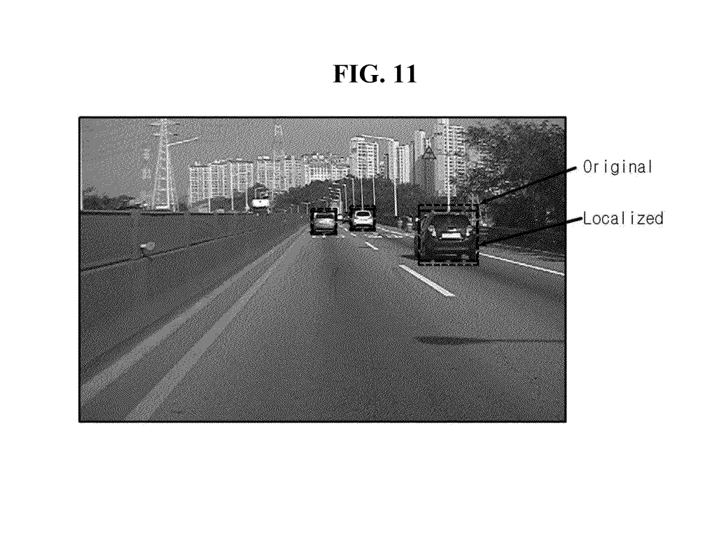

Next, a boundary compensation, in which the region of a specific object is enlarged or reduced in accordance with a boundary of the vehicle, is performed as shown in FIG. 11 (S600).

In the boundary compensation, the region may be enlarged or reduced at a rate varied according to a vehicle type, and the boundary compensation may be omitted.

Next, the warning generating unit 107 calculates distances between each object signifying forward vehicles and the vehicle (S700), and calculates collision times by calculating speeds of the objects and the vehicle.

The warning generating unit 107 outputs the warning generating signal when a collision time is in the predetermined range (S800).

The position of the vehicle in the current image frame is calculated by calculating the distance between the object and the vehicle. In this case, the applied inner parameter includes a pixel size, VFOV, HFOV, and an image area, and the external parameter includes a location of the camera and a gradient of the camera.

When the distance between the object and the vehicle is calculated, the collision time is calculated according to the speeds of the object and the vehicle.

When the collision time is more than the threshold time, the warning generating signal is output. When the collision time is less than the threshold time, the warning is not generated by assuming that the lane departure already occurs (S740). As the threshold time is time elapsed until the vehicle is stopped at a current speed, the threshold time may be varied according to the current speed.

Thus, when the warning generating signal generated from the driving unit 110 is transferred to the warning unit 160, the warning unit 160 warns a driver visually and acoustically.

Although a preferred embodiment of the disclosure has been described for illustrative purposes, those skilled in the art will appreciate that various modifications, additions and substitutions are possible, without departing from the scope and spirit of the invention as disclosed in the accompanying claims.

What is claimed is:

1. A forward collision warning system comprising:
a photographing unit attached to a front of a vehicle to photograph an object in a forward direction of the vehicle;
a driving unit that receives image data from the photographing unit to search for a forward candidate vehicle by classifying the image data using a predetermined mask, filters the candidate vehicle to settle an object corresponding to a real vehicle, tracks the object in a plurality of frames in order to add a missed object, and calculates a collision time based on a distance between the object and the vehicle to generate a warning generating signal according to the collision time; and
a warning unit to generate a forward collision warning signal based on the warning generating signal received from the driving unit.

2. The forward collision warning system of claim 1, wherein the driving unit comprises:
a vehicle searching unit that receives the image data from the photographing unit to search for the forward candidate vehicle by classifying the image data using the predetermined mask, and filters the candidate vehicle in order to settle the object corresponding to the real vehicle;
a post processing unit that tracks the object in the plurality of frames to add the missed object; and
a warning generating unit that calculates the collision time to generate the warning generating signal according to the collision time.

3. The forward collision warning system of claim 2, wherein the driving unit further comprises a vehicle tracking unit to track a current object based on the object of previous image data.

4. The forward collision warning system of claim 3, wherein the vehicle searching unit and the vehicle tracking unit are selectively driven.

5. The forward collision warning system of claim 4, wherein the vehicle searching unit and the vehicle tracking unit divide a region of interest such that a calculation value is assigned to each of the masks and compare a calculation value of a reference vehicle with a calculation value of the divided region of interest to extract the candidate vehicle.

6. The forward collision warning system of claim 5, wherein the masks have mutually different shapes.

7. The forward collision warning system of claim 4, wherein the vehicle searching unit and the vehicle tracking unit extract the candidate vehicle by using modified Haar classification.

8. The forward collision warning system of claim 7, wherein the vehicle searching unit and the vehicle tracking unit settle the object except for a region, in which a real vehicle does not exist, by filtering a candidate vehicle through HOG and SVM classification.

9. The forward collision warning system of claim 8, wherein the vehicle searching unit and the vehicle tracking unit check a history by overlapping an object of a current frame with an object of a previous frame.

10. The forward collision warning system of claim 4, wherein the post processing unit compensates for the object by enlarging or reducing a boundary of the object.

11. A forward collision warning method comprising:
photographing an object in a forward direction of the vehicle to generate image data;
classifying the entire image data every n^{th} frame using a predetermined mask to search for a forward candidate vehicle, and filtering the candidate vehicle to settle an object corresponding to a real vehicle;
searching for the forward candidate vehicle corresponding to data of a settled object of a previous frame among frames except for the n^{th} frame, and filtering the candidate vehicle to settle the object corresponding to the real vehicle; and
calculating a collision time based on a distance between the object and the vehicle to generate a warning generating signal according to the collision time.

12. The forward collision warning method of claim 11, wherein the searching of the candidate vehicle includes classifying the image data by using modified Haar classification.

13. The forward collision warning method of claim 11, wherein the searching of the candidate vehicle includes settling the object except for a region, in which the real vehicle does not exist, by filtering a candidate vehicle through HOG and SVM classification.

14. The forward collision warning method of claim 13, further comprising:
checking a history by overlapping an object of a current frame with an object of a previous frame.

15. The forward collision warning method of claim 14, wherein the checking of the history includes determining that the objects of the current frame and the previous frame are the same when an overlap degree between the objects of the current frame and the previous frame is equal to or more than 70%.

16. The forward collision warning method of claim 13, further comprising:
enlarging or reducing a boundary of the object after the object is settled.
